(19) United States
(12) Patent Application Publication
(10) Pub. No.: US 2006/0049607 A1
(43) Pub. Date: Mar. 9, 2006

(54) Side wheels bicycle

(76) Inventor: Steve Sanghoo Kim, Des Plaines, IL (US)

Correspondence Address: Steve S. Kim, Apt 201, 1480 Jefferson St, Des Plaines, IL, 60016, US

(21) Appl. No.: 10/934,057

(22) Filed: Sep. 7, 2004

(51) Int. Cl. B62K 17/00

(52) U.S. Cl. 280/208

(57) ABSTRACT

I invented a new SIDE WHEELS BICYLE which have two wheels at the left and right sides of rider without chain. This new bicycle may run much faster than existing bicycles, because of the rotating power deliver directly to the two wheels without chain. It will be good for sports, fun or transportation.

### BACK GROUND OF THE INVENTION

I thought that present bicycles are not powerful, because the power delivers to rear wheel only, and the power may loses through the long chain. So, I invented a new SIDE WHEELS BICYCLE which have two wheels at left and right side of rider, and the rotating power by pedals delivers directly to the two wheels. The moving direction and axis forms right angle. This new SIDE WHEELS BICYCLE will run much faster than existing bikes, and it may be good for sports, fun or transportation. Handlebar or any accessories are optional. Size of wheels are also various.

### BRIEF SUMMARY OF THE INVENTION

I invented a new SIDE WHEELS BICYCLE which have two wheels at left and right side of rider without a chain. The rotating power by pedals delivers to the both wheels directly, so it may be much faster than existing bikes, and it will good for sports, fun or transportation. The moving direction and axis of two wheels forms right angle (90 degree). Because of there is no chain in the new bicycle, construction is simple and small, but powerful. Handlebar or any accessorie are optional, and size of the wheels are various.

### BRIEF DESCRIPTION OF THE SEVERAL VIEWS OF THE DRAWING

FIG. 1: Regular total view: It shows the new bike has no chain and power delivers to the wheels directly. The wheels placed to the left and right sides of rider.

FIG. 2: Top view: It shows the moving direction and axis forms right angle (90 degree).

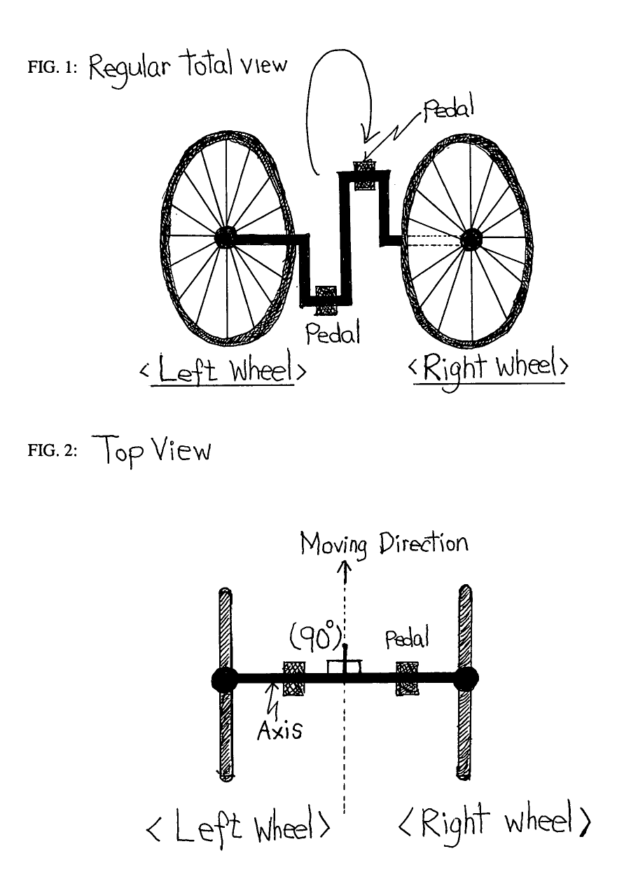

### DETAILED OF THE INVENTION

I invented a new bicycle. It is a SIDE WHEELS BICYCLE. This a new SIDE WHEELS BICYCLE have two wheels at left and right side of rider. The rotating power by pedals deliver to the two wheels directly without chain. The moving direction and axis of wheels form right angle (90). Because, the power deliver directly to two wheels without chain, the new SIDE WHEELS BICYCLE will run much faster than exist bike, and good for sports, fun and transportation. The rider's balance can be kept through practice, or two sticks can be used. Handle bar, sticks, seat or other accessories are optional. The sizes of wheels are various for children, women or men.

I claim:

1. I claim to give me a patent number for my a new SIDE WHEELS BICYCLE which have two wheels at left and right sides of rider, which means the moving direction and axis of wheels forms a right angle (90 degree).
